(19) United States
(12) Patent Application Publication
(10) Pub. No.: US 2006/0179305 A1
(43) Pub. Date: Aug. 10, 2006

(54) WLAN session management techniques with secure rekeying and logoff

(76) Inventor: Junbiao Zhang, Bridgewater, NJ (US)

Correspondence Address: THOMSON LICENSING INC., PATENT OPERATIONS, PO BOX 5312, PRINCETON, NJ, 08543-5312, US

(21) Appl. No.: 10/549,408

(22) PCT Filed: Mar. 11, 2004
(86) PCT No.: PCT/US04/07403

§ 371 Date: Sep. 14, 2005

(51) Int. Cl. H04L 9/00

(52) U.S. Cl. 713/168

(57) ABSTRACT

The invention provides a method for improving the security of a mobile terminal in a WLAN environment by installing two shared secrets instead of one shared secret, the initial session key, on both the wireless user machine and the WLAN access point during the user authentication phase. One of the shared secrets is used as the initial session key and the other is used as a secure seed. Since the initial authentication is secure, these two keys are not known to a would be hacker. Although the initial session key may eventually be cracked by the would be hacker, the secure seed remains secure as it is not used in any insecure communication.

### RELATED APPLICATION

This application claims the benefit of U.S. Provisional Application No. 60/454,542, filed Mar. 14, 2003, and is incorporated herein by reference.

### 1. FIELD OF THE INVENTION

The invention relates to an apparatus and a method for providing a secure communications session in a local area network, and in particular, to an apparatus and method for providing secure communications session with a mobile terminal in a WLAN with periodic key update and a secure logoff.

### 2. DESCRIPTION OF RELATED ART

The context of the present invention is the family of wireless local area networks or (WLAN) employing the IEEE 802.1x architecture having an access point (AP) that provides access for mobile devices and to other networks, such as hard wired local area and global networks, such as the Internet. Advancements in WLAN technology have resulted in the publicly accessible wireless communication at rest stops, cafes, libraries and similar public facilities (“hot spots”). Presently, public WLANs offer mobile communication device users access to a private data network, such as a corporate intranet, or a public data network such as the Internet, peer to peer communication and live wireless TV broadcasting. The relatively low cost to implement and operate a public WLAN, as well as the available high bandwidth (usually in excess of 10 Megabits/second) makes the public WLAN an ideal access mechanism, through which, mobile wireless communications device users can exchange packets with an external entity. However as will be discussed below, such open deployment may compromise security unless adequate means for identification and authentication exists.

When a user attempts to access service within a public WLAN coverage area, the WLAN first authenticates and authorizes user access, prior to granting network access. After authentication, the public WLAN opens a secure data channel to the mobile communications device to protect the privacy of data passing between the WLAN and the device. Presently, many manufacturers of WLAN equipment have adopted the IEEE 802.1x protocol for deployed equipment. Hence, the predominant authentication mechanism for WLANs utilize this standard. Unfortunately, the IEEE 802.1x protocol was designed with private LAN access as its usage model. Hence, the IEEE 802.1x protocol does not provide certain features that would improve the security in a public WLAN environment.

In a web browser based authentication method, a mobile terminal communicates with an authentication server, using a web browser operating with the Hyper Text Transfer Protocol Secured Sockets (HTTPS) protocol insures that anyone on the path between the mobile terminal and the authentication server cannot trespass upon or steal confidential user information. However, the only information the authentication server has related to the mobile terminal is its IP address.

Once a user is authenticated by a WLAN, a secure session key is established and shared by the user and the WLAN. All subsequent communication is encrypted using this session key. To prevent security attacks, as for example, attacks exploring security holes in the IEEE 802.11 WEP encryption protocol and to ensure strong security, the session key needs to be updated periodically. Indeed, if the initial session key is used as a Wired Equivalent Privacy (WEP) key, after a certain number of communication exchanges using the WEP key between the wireless user and the WLAN access point, a would be hacker may crack the key. In IEEE 802.1x, the protocol used for secure access control in a WLAN, where the session key is updated relies on an authentication server. In essence, each time the key is updated, the user needs to go through the authentication steps similar to the initial authentication. This procedure can be inefficient and impossible in some applications. The WLAN technology can benefit from a method that once the user is authenticated and the session key is established, future key updates no longer require the participation of the authentication server.

Additionally, applications handling management information, in particular, logoff requests typically require security from hacking. However, in IEEE 802.1x, such information is sent in the clear, thus leaving the mobile terminal prone to attacks in which a would be hacker can logoff an authenticated user even though the hacker does not have the session key. As such WLAN technology can benefit from a method that provides for an encrypted key update or log off request that is additionally encrypted with a session key.

### SUMMARY OF THE INVENTION

What is desired is a method for providing secure communications session between a terminal and a communications network by using a session key for encrypting the communications between the terminal and the communications network, wherein the session key may be derived from a set of keys, including a secure key that is stored in the terminal and an access point of the communications network. The secure key may also be used in providing a secure logoff mechanism.

The invention herein provides a method for improving the security of a mobile terminal in a WLAN environment by instead of installing one shared secret referred to as the initial session key on both the wireless user machine and the WLAN AP, during the user authentication phase, installing two shared keys. One of the shared keys is used as the initial session key, and the other shared key is used as a secure seed. Since the initial authenticated communication is secure, once the two secured keys have been established it is virtually impossible for a would be hacker to crack this form of protection. And although the initial session key may eventually be cracked by the would be hacker, the secure seed always remains secure, as it is not used in any insecure communication.

An embodiment of the present invention includes the process whereby during a key update, a new key is generated and exchanged between the WLAN access point and the mobile terminal. Instead of directly using this new key, the access point and the mobile terminal use this new key together with the secure seed to generate the new session key. For example, the new session key may be generated by concatenating the secure seed with the new key, and then calculating a one way hash function such as the Message Digest 5 (MD5) hash algorithm to generate a fixed string. Since the would be hacker does not have the secure seed, even if it can crack the old session key, it would not succeed in obtaining the new session key.

An embodiment of the present invention also includes the process whereby during a session logoff the mobile terminal remains secure to prevent a would be hacker from logging off the authenticated mobile terminal. The IEEE 802.1x based scheme does not provide a secure logoff because the logoff request is carried in an unencrypted frame. However, in an embodiment of the present invention the mobile terminal sends an encrypted logoff request accompanied by the secure seed. Thus even if the would be hacker cracks the session key, log off of the authenticated user would not be possible, since the secure seed appears in the logoff request and is no longer valid (a new secure seed needs to be negotiated each time the user logs in), thus even if the old secure seed is cracked by the would be hacker, no further harm will result.

An embodiment of the present invention also includes a method for providing a secure communications session between a mobile terminal and a wireless local access network (WLAN), the method comprising the steps of: generating first and second secure keys; transmitting the first and second secure keys to the mobile terminal using a secure communications method, the first and second secure keys being stored in the mobile terminal for use during the secure communications session; encrypting and transmitting data to the mobile terminal using a current session key, and receiving and decrypting data received from the mobile terminal using the current session key, the first secure key initially being used as the current session key; and periodically generating a subsequent session key using the second secure key and using the subsequent session key as the current session key during subsequent communications between the WLAN and the mobile terminal.

The present invention also includes an apparatus for providing a secure communications session between a mobile terminal and a WLAN, comprising a means for generating a first and second secure key and a means for transmitting the first and second secure key to the mobile terminal. The mobile terminal stores the first and second secure keys for decryption of subsequently received data. In the WLAN a means encrypts and transmits data to the mobile terminal using a current session key. In the WLAN a means to periodically generate a subsequent session keys uses the second secure key and uses subsequent session keys as the current session key during communications between the WLAN and the mobile terminal.

### BRIEF DESCRIPTION OF THE DRAWINGS

The invention is best understood from the following detailed description when read in connection with the accompanying drawing. The various features of the drawings are not specified exhaustively. On the contrary, the various features may be arbitrarily expanded or reduced for clarity. Included in the drawing are the following figures:

FIG. 1 is a block diagram of a communications system for practicing the method of the present principles for authenticating a mobile wireless communications device.

FIG. 2 is a flow diagram of the method of establishing two secure keys of the present invention.

FIG. 3 is a flow diagram of the method of establishing a secured log off procedure on the present invention.

FIG. 4 is a block diagram of an apparatus for implementing the present invention.

### DETAILED DESCRIPTION OF THE INVENTION

In the figures to be discussed the circuits and associated blocks and arrows represent functions of the process according to the present invention which may be implemented as electrical circuits and associated wires or data busses, which transport electrical signals. Alternatively, one or more associated arrows may represent communication (e.g., data flow) between software routines, particularly when the present method or apparatus of the present invention is implemented as a digital process.

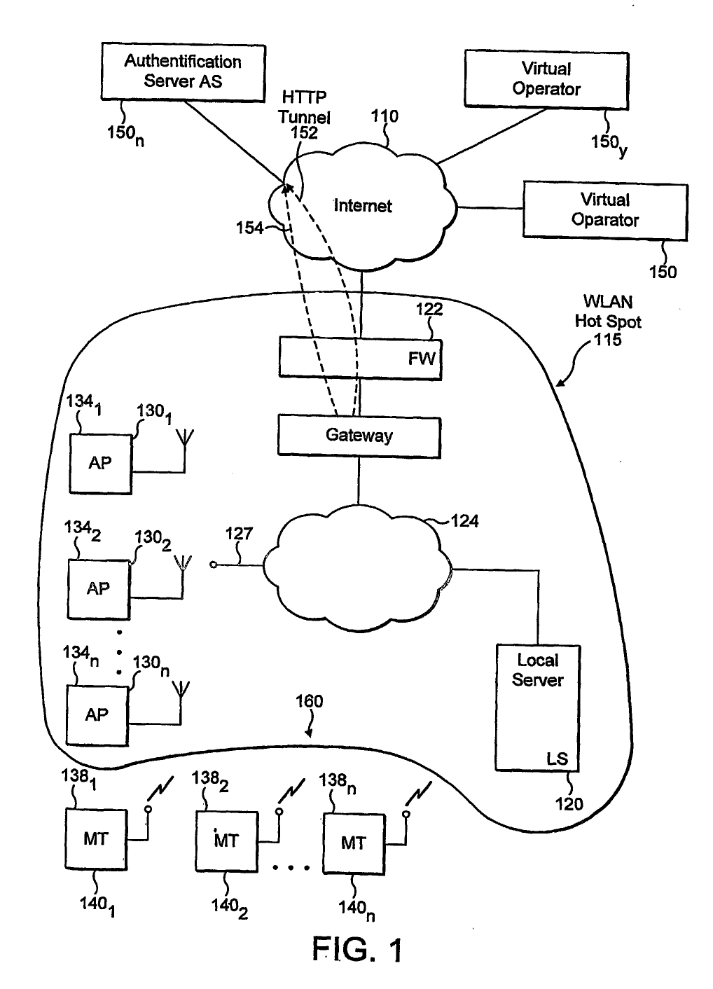

In accordance with FIG. 1, one or more mobile terminals represented by 140₁, through 140ₙ communicate through an access point 130ₙ, local computer 120, in association with firewalls 122 and one or more virtual operators 150₁₋ₙ, such as authentication server 150ₙ. Communication from terminals 140₁₋ₙ typically require accessing a secured data base or other resources, utilizing the Internet 110 and associated communication paths 154 and 152 that require a high degree of security from unauthorized entities, such as would be hackers.

As further illustrated in FIG. 1, the IEEE 802.1x architecture encompasses several components and services that interact to provide station mobility transparent to the higher layers of a network stack. The IEEE 802.1x network defines stations such as access points 130₁₋ₙ and mobile terminals 140₁₋ₙ, as the components communication in the wireless medium 124 and contain the functionality of the IEEE 802.1x protocols, that being MAC (Medium Access Control) 138₁₋ₙ, and corresponding PHY (Physical Layer) (not shown), and a connection 127 to the wireless medium. Typically, the IEEE 802.1x functions are implemented in the hardware and software of a wireless modem or a network access or interface card. This invention proposes a method for implementing an identification means in the communication stream such that an access point 130₁₋ₙ compatible with the IEEE 802.1x WLAN MAC layers for downlink traffic (i.e. from the an authentication server to the mobile terminal such as a laptop) may participate in the authentication of one or more wireless mobile devices 140_{1-n,}, a local or back end server 120 and an authentication server 150.

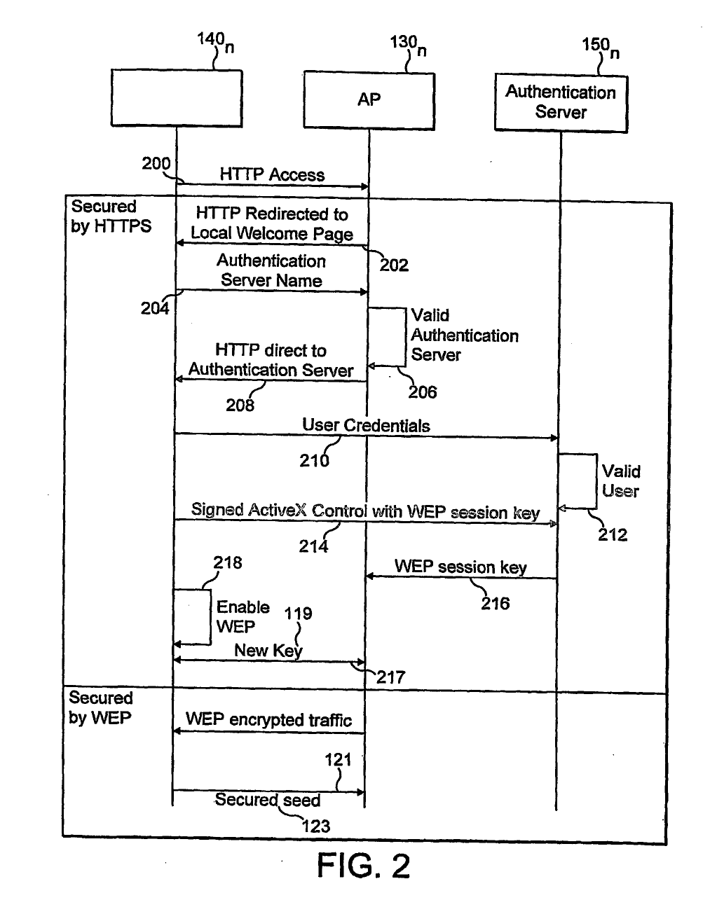

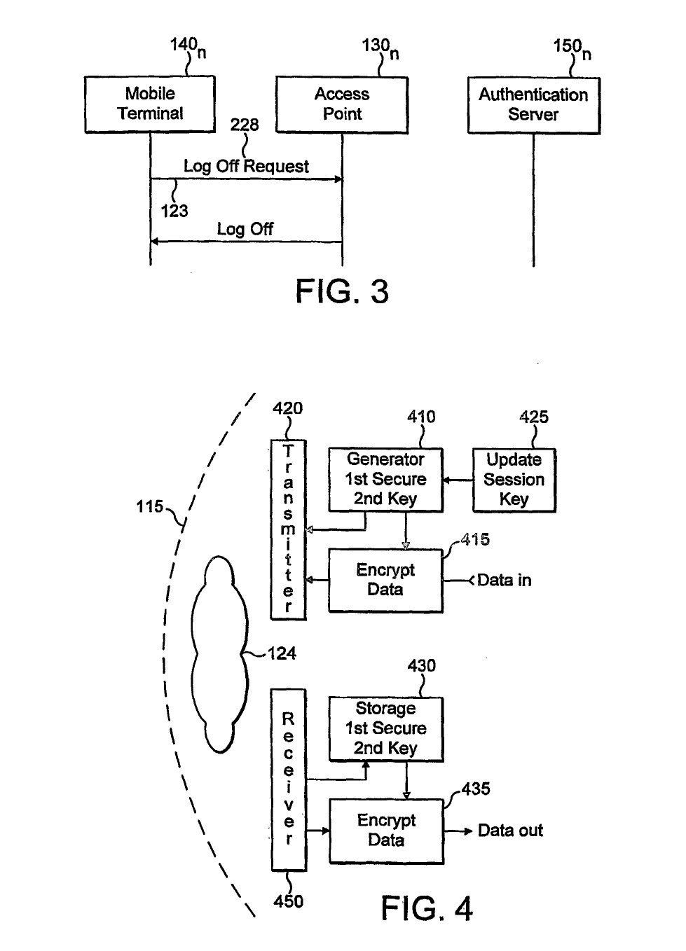

In accordance with the present principles, the access 160 enables each mobile terminals 140₁₋ₙ, to securely access the WLAN 115 by authenticating both the mobile terminal itself, as well as its communication stream in accordance with the IEEE 802.1x protocol. The manner in which the access 160 enables such secure access can best be understood by reference to FIG. 1 in conjunction with FIG. 2.

The sequence of interactions that occurs over time among a mobile wireless communication device, say mobile terminal 140ₙ, the public WLAN 115, the local web server 120, and the authentication server 150 is described under the convention of an IEEE 802.1x protocol, wherein the access point 130ₙ of FIG. 1 maintains a controlled port and an uncontrolled port, through which the access point exchanges information, with the mobile terminals 140₁₋ₙ. The controlled port maintained by the access point 130ₙ serves as the entryway for non-authentication information, such as data traffic to pass through the access point 130ₙ as it flows between the local server 120 and the mobile terminals 140₁₋ₙ. Ordinarily, the access points
130₁₋ₙ keep the respective controlled port closed in accordance with the IEEE 802.1x protocol, until the authentication of the pertinent mobile terminal 140₁₋ₙ communicates. The access points 130₁₋ₙ always maintain the respective uncontrolled port open to permit the mobile terminals
   140₁₋ₙ to exchange authentication data with an authentication server 150.

More specifically, with reference to FIG. 2, a method in accordance with the present invention for improving the security of a mobile terminal in 140ₙ in a WLAN environment installs two shared secrets instead of one shared secret, on both the mobile terminal 140ₙ and the WLAN access point 130ₙ during the user authentication phase. One of the shared secrets is used as the initial session key and the other is used as a secure seed. Since the initial authentication is secure, these two keys would not be known to a would be hacker. The keys may be generated and distributed to the mobile terminal and the WLAN, access point, using known methods, for example using an authentication server, for generating and distributing such keys. Although the initial session key may eventually be cracked by the would be hacker, the secure seed remains secure as it is not used in any insecure communication. More particularly, the method of the present invention processes, through the access point 130ₙ, web requests from the mobile terminal 140ₙ, so as to embed a session id 215.

With reference to FIG. 2, a method in accordance with the present invention improves the security of a mobile terminal in 140ₙ in a WLAN environment by comprising the steps of installing at least two shared secrets on both the mobile terminal 140ₙ and the WLAN access point 130ₙ during the user authentication phase, whereby a first secret is the initial session key and subsequent keys are utilized as secure seeds.

In accordance with the present principles of the invention, there is provided a technique for enabling each mobile communication device, such as each of devices 140₁-140ₙ, to securely access the WLAN 115 to afford authentication of both the device itself, as well as the traffic that emanates there from. The authentication technique utilized in FIG. 2, depicts the sequence of communications that occurs over time among the mobile terminal 140ₙ, the access point 130ₙ, and the authentication server 150. To initiate secure access, the mobile terminal 140ₙ, transmits a request for access to the access point 130ₙ, during step 200 of FIG. 2. In practice, the mobile terminal 140ₙ initiates the access request by way of a HTTPS access demand launched by a browser software program (not shown) executed by the mobile terminal 140ₙ. In response to the access request, the access point 130ₙ redirects the browser software in the mobile terminal 140ₙ to a local welcome page on the access point 130ₙ during step 202.

Following step 202, the mobile terminal 140ₙ initiates an authentication sequence by querying the access point 130ₙ for the identity of the appropriate authentication server during step 204. In response, the access point 130ₙ determines the identity of appropriate authentication server (e.g., server 150) during step 206 and then directs the browser software in the mobile terminal 140ₙ to that server via an HTTP command during step 208. Having now received the identity of the authentication server 150 during step 208, mobile terminal 140ₙ then sends its user credentials to the server during step 210 of FIG. 2.

Upon receipt of the user credentials from the mobile terminal 140ₙ, the authentication server 150 makes a determination whether the mobile terminal 140ₙ constitutes a valid user during step 212. If so, then the authentication server 150 replies to the mobile terminal 140ₙ during step 214 using a Wired Equivalent Privacy (WEP) encryption key, which the device invokes via an ActiveX command of an ActiveX control though the device browser software. The ActiveX control is essentially an executable program that can be embedded inside a web page. Many software browser programs, such Microsoft Internet Explorer have the capability of displaying such web pages and invoking the embedded ActiveX controls, which can be downloaded from a remote server (e.g., the authentication server 150). The execution of the ActiveX controls are restricted by the security mechanisms built into the browser software. In practice, most browser programs have several different selectable security levels. At the lowest level, any ActiveX control from the web can be invoked without restriction. In the highest level, no ActiveX control can be invoked from the browser software.

A method in accordance with the present invention comprises the step of, after authentication and authorization, generating a first key in step 217 and distributing the new key to the access point 130ₙ and the mobile terminal 140ₙ. In step 221 second key referenced to as secure seed 123 is distributed to the mobile terminal 140ₙ and the access point 130ₙ. Thereafter the mobile terminal and the access point communicate using the first key as the session to encrypt the data. Thereafter, the access point 130ₙ and the mobile terminal 140ₙ employ the key 119 and the secure seed 123 to periodically generate 225a new session key 121, whereby the new session key is then used for subsequent communications between the mobile terminal and the access point. The second key is always stored and kept as a secret in the mobile terminal and the access point during the communication session so that a would be hacker is unable to determine the second key. Several techniques may be employed to further facilitate the management of the combined keys such as generating the new session key and concatenating the new session key to the secure seed prior to using it for security. Once having concatenated the combined session key and secure seed, the process may calculate a hash algorithm on the concatenated new session key and secure seed and generate a fixed string for further transmission.

A method for improving the security of a mobile terminal in a WLAN environment further comprises the steps of the mobile terminal 140ₙ sending during session logoff an encrypted logoff request accompanied by the secure seed such that the secure seed appears in the logoff request. During session logoff the mobile terminal 140ₙ remains secure to prevent a would be hacker from logging off an authenticated mobile terminal 140ₙ. The IEEE 802.1x based scheme cannot provide secure logoff because the logoff request is carried in an unencrypted frame. However in an embodiment of the present invention the mobile terminal 140ₙ sends an encrypted logoff request 228 accompanied by the secure seed 123. Thus even in the case where the would be hacker cracks the session key, log off of the authenticated user on mobile terminal 140ₙ would not be possible, since the secure seed 123 appears in the logoff request 228 and is o longer used since a new secure seed needs to be negotiated each time the user logs in.

In FIG. 4, is shown an apparatus for a secure communications session between the mobile terminal 140ₙ and WLAN. The access point 130ₙ comprises a means for generating a first and second secure key 410 and a means for transmitting 420 the first secure key 119 and the second secure key 123 to the mobile terminal 140ₙ. The mobile terminal 140ₙ receives the first secure key 119 and second secure key 123 and stores the keys in a register 430 for use during the secure communications session. The access point 130ₙ includes a means to encrypt 415 data and a means to transmit 420 data to the mobile terminal 140ₙ via the WLAN 115 using a current session key. The mobile terminal 140ₙ, includes a means to receive 450 and a means to decrypt data 435 received from the access point 130ₙ using the current session key 119, the first secure key initially being used as the current session key 119. The access point 130ₙ includes a means to periodically generate 425 a subsequent session key using the second secure key and using the subsequent session key as the current session key during subsequent communications between the WLAN 115 and the mobile terminal 140ₙ.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

1. A method for providing a secure communications session with a user terminal in a communications network, the method comprising the steps of:
transmitting a secure key and a secure seed to the user terminal using a secure communications method, the secure key and the secure seed being suitable for storage in the user terminal for use during the secure communications session;
encrypting and transmitting data to the user terminal using a current session key, and receiving and decrypting data received from the user terminal using the current session key, the secure key initially being used as the current session key; and
periodically generating by an access point a subsequent session key using the secure seed and using the subsequent session key as the current session key during subsequent communications between the communications network and the user terminal.

2. The method according to claim 1, further comprising the step of:
logging off the user terminal in response to an encrypted logoff request from the user terminal accompanied by the secure seed.

3. The method according to claim 1, wherein the periodically generating step comprises generating the subsequent session key by concatenating the current session key with the secure seed and applying a hash algorithm.

4. A method for providing a secure communications session with a mobile terminal in a wireless local area network, the method comprising the steps of:
transmitting a secure key and a secure seed to the mobile terminal using a secure communications method, the secure key and the secure seed being suitable for storage in the mobile terminal for use during the secure communications session;
encrypting and transmitting data to the mobile terminal using a current session key, and receiving and decrypting data received from the mobile terminal using the current session key, the secure key initially being used as the current session key; and
periodically generating by an access point a subsequent session key using the secure seed and using the subsequent session key as the current session key during subsequent communications with the mobile terminal.

5. The method as in claim 4, wherein the periodically generating step comprises generating by the AP a subsequent session key using a combination of a new key and the secure seed, the new key being generated using the secure key.

6. The method as in claim 5, wherein the periodically generating step comprises generating by the AP a subsequent session key by concatenating the new key and the secure seed and running a hash algorithm to generate the subsequent session key.

7. A method for providing a secure communications session with a mobile terminal in a wireless local area network, the method comprising the steps of:
generating a secure key;
transmitting the secure key to the mobile terminal using a secure communications method, the secure key being stored in the mobile terminal for use during the secure communications session;
encrypting and transmitting data to the mobile terminal using a current session key, and receiving and decrypting data received from the mobile terminal using the current session key; and
ending the secure communications session by an access point in response to receiving a logoff message from the mobile terminal, the logoff message being in encrypted form and including the secure key.

8. A method for providing a secure communications session with a mobile terminal in a wireless local area network, the method comprising the steps of:
generating a secure key and a secure seed;
transmitting the secure key and the secure seed to the WLAN using a secure communications method, the secure key and the secure seed being stored in the WLAN for use during the secure communications session;
encrypting and transmitting data to the WLAN using a current session key, and receiving and decrypting data received from the WLAN using the current session key, the secure key initially being used as the current session key; and
periodically generating by the mobile terminal a subsequent session key using the secure seed and using the subsequent session key as the current session key during subsequent communications with the WLAN.

9. The method as in claim 8, wherein the periodically generating step comprises generating by the mobile terminal a subsequent session key using a combination of a new key and the secure seed, the new key being generated using the secure key.

10. The method as in claim 9, wherein the periodically generating step comprises generating by the mobile terminal a subsequent session key by concatenating the new key and the secure seed and running a hash algorithm to generate the subsequent session key.

11. A method for providing a secure communications session with a mobile terminal in a wireless local area network, the method comprising the steps of:
generating a secure key;
receiving the secure key from the WLAN using a secure communications method, the secure key being stored in the WLAN for use during the secure communications session;
encrypting and transmitting data to the WLAN using a current session key, and receiving and decrypting data received from the WLAN using the current session key; and
ending the secure communications session in response to receiving a logoff message from the WLAN, the logoff message being in encrypted form and including the secure key.

12. A method for providing a secure communications session with a mobile terminal in a wireless local area network, the method comprising the steps of:
installing at least two shared secrets on both the mobile terminal and the WLAN access point during the user authentication phase whereby a first secret is the initial session key and a second secret is utilized as secure seed to generate subsequent session keys.

13. The method as in claim 12, further comprising the step of generating a new key and encrypting the new key with the current session key and exchanging and the new key between the WLAN and the mobile terminal.

14. The method as in claim 12, further comprising the step of the WLAN and the mobile terminal generating a new session key employing the new session key and the secure seed.

15. The method as in claim 14, wherein generating the new session key generation comprises the step of concatenating the said new session key to the secure seed.

16. The method as in claim 15, further comprising the step of generating a new session key by applying a hash algorithm on said concatenated result.

17. The method as in claim 16, further comprising the step of using the said new session key in communications between the WLAN and mobile terminal.

18. A method for providing a secure communications session between a mobile terminal and a wireless local area network, the method comprising the steps of:
a mobile terminal sending during session logoff an encrypted logoff request accompanied by the secure seed such that the secure seed appears in the logoff request.

19. An access point for providing a secure communications session between a mobile terminal and a wireless local area network, comprising:
a means for transmitting a secure key and a secure seed to the mobile terminal using a secure communications method;
a means to encrypt data using the secure key; and
a means to periodically generate a subsequent session key using the secure seed.

20. A terminal device for providing a secure communications session with a communications network, comprising:
a means to receive a secure key and a secure seed and a means to store the secure key and the secure seed for use during the secure communications session;
a means to receive data and a means to decrypt the data using a current session key during the secure communications session, the secure key being using initially as the current session key; and
a means to generate a subsequent session key using the current session key and the secure seed, the subsequent session key thereafter being used as the current session key for subsequent communications.

21. The terminal device according to claim 20, wherein the terminal device comprises a mobile terminal and the communications network comprises a wireless local area network.

22. The access point according to claim 24, wherein the means to periodically generate a subsequent session key comprises a means to generate a subsequent session key using a combination of a new key and the secure seed, the new key being generated by means using the secure key.

23. The access point according to claim 24, wherein the means to periodically generate a subsequent session key comprises a means to generate a subsequent session key by concatenating a new key and the second secure seed and a means for running a hash algorithm to generate the subsequent session key.

24. An access point for providing a secure communications session between a mobile terminal and a wireless local area network, comprising:
a means to transmit a secure key and a secure seed and a means to store the secure key and the secure seed for use during the secure communications session;
a means to encrypt data and a means to transmit data to the mobile terminal and a means to receive data and a means to decrypt the data from the mobile terminal using a current session key during the secure communications session, the secure key being using initially as the current session key; and
a means to generate a subsequent session key using the current session key and the secure seed, the subsequent session key thereafter being used as the current session key for subsequent communications.
